(19) United States
(12) Patent Application Publication
(10) Pub. No.: US 2003/0012945 A1
(43) Pub. Date: Jan. 16, 2003

(54) Double sided adhesive tape for mounting printing plates, especially multilayer photopolymer printing plates, to printing cylinders or sleeves

(76) Inventors: Torsten Runge, Hamburg (DE); Bianca Mayer, Hamburg (DE); Andrea Fick, Hamburg (DE); Jochen Fiencke, Hamburg (DE)

Correspondence Address: WILLIAM GERSTENZANG, NORRIS, MCLAUGHLIN & MARCUS, P.A., 220 EAST 42ND STREET, 30TH FLOOR, NEW YORK, NY, 10017, US

(21) Appl. No.: 10/120,690

(22) Filed: Apr. 11, 2002

(30) Foreign Application Priority Data
Jun. 20, 2001 (DE) 101 29 730.0

(51) Int. Cl. B32B 3/26; B32B 1/00; B32B 7/12; D06N 7/04

(52) U.S. Cl. 428/317.1; 428/141; 428/343; 428/304.4; 428/318.4; 428/319.3; 428/319.7

(57) ABSTRACT

A double sided adhesive tape for mounting printing plates, especially multilayer photopolymer printing plates, to printing cylinders or sleeves, the carrier of the adhesive tape being a polyethylene terephthalate (PET) film and self-adhesive coatings being applied to both sides of the film, wherein the surface of the polyethylene terephthalate (PET) film is at least partly roughened on one or both sides using a reagent and/or the surface energy of the surface of the film is increased.

The invention describes a double sided adhesive tape for mounting printing plates, especially multilayer photopolymer printing plates, to printing cylinders or sleeves in the printing industry.

In the printing industry a variety of processes are known for transferring designs to, say, paper by way of printing originals. One possibility is that known as flexographic printing. One version of flexographic printing, in turn, uses multilayer photopolymer printing plates with a flexible substructure, this kind of printing having been part of the art for a relatively long time. The printing plates in this case are composed of a plurality of layers of different polymeric material, each having specific functions. For example, the nyloflex MA and nyloflex ME printing plates from BASF AG have three layers: a photosensitive relief layer, a stabilizing film below it, and an elastic support layer as the base.

For the printing operation, the printing plates have to be mounted on printing cylinders. This is generally done by adhesive bonding, using in particular a self-adhesive tape. This adhesive tape is required to have the following properties:

Both the adhesive tape and the printing plate must be repositionable without damage before printing, in order to allow any inaccuracies in the alignment of the tape and/or plate to be easily corrected.

During the printing operation, the printing plates must adhere very strongly to the printing cylinder. Even very small plate displacements lead to completely inadequate results, as a result of registration problems.

After printing, on the other hand, it must again be possible to detach the plate and the adhesive tape from the printing cylinder easily, in particular without residue, and without damage to the plate.

The extent to which the known adhesive tapes meet the above requirements is deficient. On the one hand, certain adhesive tapes, although capable of allowing repositioning of the printing plates because of weak bonding, exhibit insufficient adhesiveness following prolonged printing use, so that in the course of printing the plates begin to “wander” or the plate edges lift. On the other hand, there are adhesive tapes which, through high adhesive forces, ensure secure anchoring of the plates to the cylinder but whose adhesive layer, after printing, is transferred to the plate, from the reverse face of which it can only be removed using solvents.

DE 195,25,403 A1 proposes the use of a double sided adhesive tape for mounting multilayer plasticized photopolymer printing plates with a flexible substructure to printing cylinders.

The carrier of the adhesive tape is a polypropylene film. As an alternative to polypropylene, the use of PVC, for example, as a carrier material is possible.

The two outer faces of the carrier are coated using two different adhesives. On the side of the adhesive tape which is mounted on the support layer of the printing plate, an extremely weakly adhering natural rubber adhesive is applied. The adhesive has a bond strength of from 0.2 to 2 N/cm, preferably 1 N/cm.

The other coating is formed by a strongly adhering layer which preferably is likewise based on natural rubber. An alternative option is to use an adhesive based on conventional acrylates. This coating is characterized by a bond strength of from 2 to 6 N/cm, preferably 4.5 N/cm.

The stated bond strengths are measured in accordance with AFERA 4001.

In the printing industry, and especially in flexographic printing, use is also especially made of compressible double sided adhesive tapes for bonding printing plates to printing cylinders or sleeves, these tapes being known as soft foam plate mounting tapes.

Plate mounting tapes with foam carriers require a stabilizing film, made of PET for example, which prevents stretching and thus a change in thickness of the adhesive tape during mounting and repositioning of the tape and of the plate. Furthermore, the stabilizing film serves to distribute forces during the printing process.

Since the reverse of the plates, facing the adhesive tape, is likewise made from a PET film, it is necessary to assist the anchoring of the pressure sensitive adhesive on the stabilizing film of the plate mounting tape by means of a pretreatment. Only in this way is it possible to prevent transfer of the pressure sensitive adhesive from the plate mounting tape to the plate when the plate is removed. Known pretreatment methods include Corona pretreatment and/or precoating of the film.

It is an object of the invention to provide an adhesive tape which when used, for example, in the printing industry suppresses any transfer of pressure sensitive adhesives from the plate mounting tape to the plate and does not have the disadvantages of the prior art, or at least not to the same extent.

This object is achieved by means of a double sided adhesive tape as specified in the claims. The dependent claims relate to advantageous embodiments of the invention and to particularly advantageous uses thereof.

The invention accordingly provides a double sided adhesive tape for mounting printing plates, especially multilayer photopolymer printing plates, to printing cylinders or sleeves, the carrier of the adhesive tape being a polyethylene terephthalate (PET) film and the film bearing self-adhesive coatings on both sides.

The surface of the polyethylene terephthalate (PET) film is at least partly roughened on one or both sides using a reagent, which specifically causes etching, and/or the surface energy of the film surface is increased, thereby optimizing the anchoring of adhesive on the film.

By surface energy or surface tension is meant the tension of solids and liquids at their interface with the vapor phase and/or air. The diagram illustrates the importance of surface energy for liquids.

[image]

Whereas in the liquid (a) equal forces of attraction (intermolecular forces) act on the molecules from all directions, these forces are not compensated at the liquid/vapor interface (b). There exists a force, directed into the interior of the liquid, which attempts to drive molecules from the surface into the liquid. The liquid therefore attempts to reduce its surface area, which is why droplets and gas bubbles attempt to adopt a spherical form.

Surface energy is defined as surface force per unit length and has the dimension mN/m (10⁻³ newton/meter).

Surface work refers to the work necessary in order to form the surface or to enlarge it under reversible conditions and with an isothermic course. Given certain assumptions, the surface energy corresponds to the free energy or Helmholtz energy of the surface per unit area.

Immediately following the formation of the surface, surface energy values which deviate from the equilibrium state are obtained. This effect is referred to as dynamic, the equilibrium value as static surface tension.

The surface energy can be determined by methods including the following:

(a) meniscus formation and height of rise in capillaries

(b) bubble pressure of a gas bubble emerging into the liquid

(c) ring method

(d) Wilhelmy method

(e) form of sessile or pendant drops

For the testing of surfactants, method (c) is standardized by DIN 53914: 1980-03.

By means of a partial preferential etching, in the form for example of indicia, lines, dots or other designs, it is possible to bring about targeted strengthening of the anchoring of adhesive at certain sites.

In this way, predetermined breakage points are formed at which the adhesive transfers when the adhesive tape is removed.

The residues of adhesive and the damaged adhesive tape themselves disclose removal of the adhesive tape in the case, for example, of unauthorized opening of cartons.

These properties are of great importance in particular in the context of use as adhesive security tape.

Polyethylene terephthalates are polyesters from the polyalkylene terephthalate group and have the structure 1.

They are prepared industrially

1. by transesterification of dimethyl terephthalate with ethylene glycol, accompanied by elimination of methanol, to give bis(2-hydroxyethyl) terephthalate, which is subjected to polycondensation with release of ethylene glycol, or

2. by direct polycondensation of ethylene glycol and terephthalic acid:

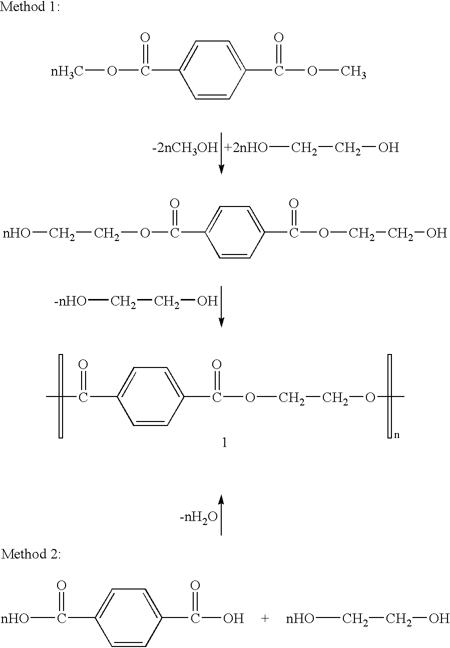

Since terephthalic acid is presently obtainable in a highly pure form, the 2nd method is becoming increasingly important (advantages: lower material consumption, higher reaction rate, methanol reprocessing and transesterification catalysts not required). Industrially, polyethylene terephthalate is prepared in continuous and batch processes.

Polyethylene terephthalates (density about 1.38 g/cm³, melting point about 260° C.) are partially crystalline products of high strength, rigidity and dimensional stability and have good slip and wear properties and also high chemical stability. By incorporation of foreign building blocks (isophthalic acid and/or 1,4-cyclohexanedimethanol), the degree of crystallinity (30 to 40%) is reduced. The resulting copolyesters possess high transparency, toughness and dimensional stability, and favorable durability, wear, slip, and stress cracking properties.

In order to adapt them to the requirements composed for each individual field of use, the polyethylene terephthalates are also used in modified form, as blends for example with polycarbonates or polybutylene terephthalates.

In the printing industry in particular it is important for the adhesive tapes used here to exhibit high flexibility; in other words, to be able to change their thickness to a certain extent under pressure and, respectively, to regain their original form following removal of the load.

For this reason, in a further advantageous embodiment of the double sided adhesive tape, there is a foamed carrier between the polyethylene terephthalate (PET) film and at least one adhesive, in particular between the adhesive facing the printing cylinder or sleeve and the polyethylene terephthalate (PET) film, where the adhesive tape is used in the printing industry.

It is further advantageous for the foamed carrier to be composed of polyurethane, PVC or polyolefin(s).

It is also preferable for the surfaces of the foam carrier to have been physically pretreated, in particular by corona pretreatment.

With further preference, the polyethylene terephthalate (PET) film has a thickness of from 5 μm to 500 μm, more preferably from 5 μm to 60 μm, with very particular preference 23 μm.

A further advantage is the outstanding and durable printability of the etched, pretreated polyethylene terephthalate (PET) film on one or both sides, which can be done without an additional, otherwise customary, physical pretreatment.

This printing can be applied beneath a subsequent pressure sensitive adhesive; there is now no longer any need for subsequent aggressive pretreatment methods for improving the anchoring of the adhesive, and especially not for chemical primers, which attack the ink.

In another advantageous embodiment of the invention, therefore, the polyethylene terephthalate (PET) film has been printed on one or both sides.

It is also preferable for the surfaces of the polyethylene terephthalate (PET) film to have been physically pretreated, in particular by corona pretreatment.

In order to obtain very good roughening results it is advisable to use, as the reagent, trichloroacetic acid (Cl₃C—COOH) alone or in combination with inert crystalline compounds, preferably silicon compounds, with particular preference [SiO₂]ₓ. The purpose of the inert crystalline compounds is to be incorporated into the surface of the PET film in order to increase the roughness and the surface energy.

In order to tailor the desired properties of the adhesive tape, especially the requisite cohesion and the required reversibility after the end of the printing operation, it is possible to add tackifier resins and fillers such as, inter alia, hydrocarbon resins, plasticizers, aging inhibitors or chalk to the adhesives.

Furthermore, the adhesive tape may have been provided on one or both sides with a liner made of paper or an appropriate film, in particular a double-sidedly siliconized liner, in order to ensure a long storage life and comfortable handling during service.

Owing to its special properties, the double sided adhesive tape of the invention can be used outstandingly for mounting printing plates, especially multilayer photopolymer printing plates, to printing cylinders or sleeves.

In this particular case it has proven advantageous if two different adhesives are used to coat the two outer faces of the carrier.

The side of the adhesive tape that is mounted on the support layer of the printing plate is then coated with a weak acrylic adhesive. The adhesive has in particular a bond strength of from 0.5 to 5 N/cm, preferably 2.5 N/cm.

The other adhesive coating is formed by a more strongly adhering film which preferably is likewise based on acrylate. This coating is characterized in particular by a bond strength of from 1 to 6 N/cm, preferably 4.5 N/cm. The bond strengths stated are measured in accordance with AFERA 4001.

The desired bond strengths of the respective layer can be varied by the nature and amount of the resins and fillers used.

Owing to its particular configuration, especially with the bond strengths tailored to the printing plate, the adhesive tape of the invention is outstandingly suitable for the adhesive bonding of the printing plates to the printing cylinders. On the one hand it is possible to reposition the printing plates as often as desired before commencement of printing; on the other hand, however, a firm bond of the plate during the printing operation is ensured. Finally, after printing, the printing plate can be removed without residue and without any damage from the adhesive tape, with the adhesive tape initially remaining on the printing cylinder. Peeling of the support layer of the plate, or the formation of unwanted folds in the plate during removal, does not occur. Furthermore, the adhesive tape can be removed from the printing cylinder without any residue of the adhesive coating remaining on said cylinder.

In a second preferred use of the double sided adhesive tape with partial etching, it is used as an adhesive security tape which indicates unauthorized opening of the article adhesively bonded using said adhesive security tape.

This occurs by virtue of the adhesive tape splitting during the act of opening, and so becoming irreversibly divided.

Below, the advantages of the adhesive tape of the invention are demonstrated by way of example in a number of tests against two conventional adhesive tapes.

Using an acrylic, natural rubber, synthetic rubber or polyurethane pressure sensitive adhesive, especially an acrylic pressure sensitive adhesive, comparative measurements were carried out with differently pretreated PET films.

In the course of these tests, the highest adhesive anchoring values were found unambiguously for the etched film, and particularly for the etched film with additional Corona pretreatment.

| | Comparative | Comparative | | |
|---|---|---|---|---|
| | test 1 | test 2 | Test 1 | Test 2 |
| Type of | Corona | Corona and | Etched film | Etched film |
| pretreatment | | precoat | | and corona |
| Adhesive | 4.0 | 4.5 | 5.2 | 6.8 |
| anchoring | | | | |
| force [N/cm] | | | | |

In order to measure the adhesive anchoring values, the films were coated directly from solution with an acrylic adhesive and dried at 100° C. for 30 minutes. The resulting specimens were affixed by the uncoated side to a solid substrate by means of a commercial double sided adhesive tape. The exposed adhesive of the resultant assembly was laminated with 20 mm wide strips of the etched film.

These strips were rolled on and peeled off in accordance with AFERA 4001. The force measured during this operation is a measure of the anchoring of the adhesive, since during the measurement the adhesive underwent transfer from the originally directly coated carrier onto the test strips.

As a result of the omission of the precoat, which is normally applied at extremely low thicknesses with relatively high tolerances, it is in addition a more uniform pretreatment of the film.

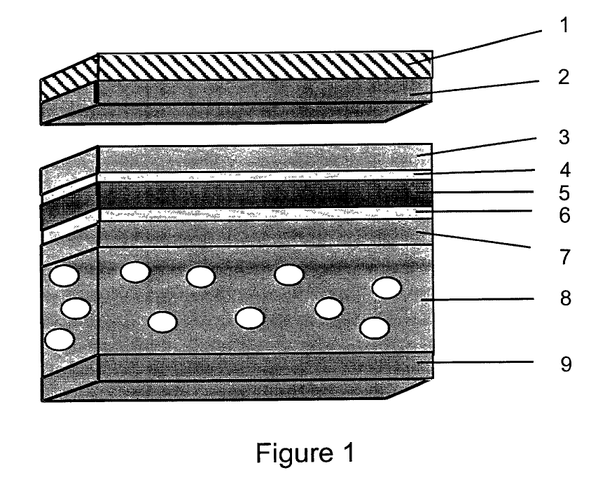

FIG. 1 shows the adhesive tape of the invention in a particularly advantageous embodiment and utility, without wishing unnecessarily to restrict the invention as a result.

The adhesive tape is used to bond a printing plate which is composed of a PET film 2 and a photopolymer layer 1.

Layers 3 to 9 constitute a double sided adhesive plate mounting tape which is compressible by virtue of its foamed carrier 8.

Beginning from the side with which the printing plate is bonded, the adhesive tape is composed of the following individual sections:

3 pressure sensitive adhesive for anchoring the plate

2 the roughened top surface, etched using trichloroacetic acid, of the polyethylene terephthalate (pet) film 5

5 polyethylene terephthalate (pet) film

6 the roughened bottom surface, etched using trichloroacetic acid, of the polyethylene terephthalate (pet) film 5

7 pressure sensitive adhesive for anchoring the foamed carrier 8 to the polyethylene terephthalate (pet) film 5

8 foamed carrier

9 pressure sensitive adhesive for anchoring on the printing cylinder

We claim:

1. A double sided adhesive tape for mounting multilayer photopolymer printing plates to printing cylinders or sleeves, comprised of a polyethylene terephthalate film having self-adhesive coatings on both sides of the film, wherein
the surface of the polyethylene terephthalate film is treated with a reagent to roughen the surface on one or both sides of the film, to increase the surface energy of the surface on one or both sides of the film, or both.

2. The double sided adhesive tape of claim 1, further comprising a foamed carrier between the polyethylene terephthalate film and the adhesive coating on at least one side.

3. The double sided adhesive tape of claim 1, wherein the polyethylene terephthalate (PET) film has a thickness of from 5 μm to 500 μm.

4. The double sided adhesive tape of claim 1, wherein the polyethylene terephthalate film is printed on one or both sides.

5. The double sided adhesive tape of claim 2, wherein the foamed carrier is composed of polyurethane, PVC or polyolefin(s).

6. The double sided adhesive tape of claim 1, wherein said reagent is trichloroacetic acid, either alone or in combination with inert crystalline compounds.

7. The double sided adhesive tape of claim 1, wherein the polyethylene terephthalate film is also treated on one or both sides by a corona, plasma or flame process.

8. A method for adhesively bonding printing plates to printing cylinders or to sleeves, which comprises bonding said printing plates to said printing cylinders or sleeves with the double sided adhesive tape of claim 1.

9. An adhesive security tape which indicates unauthorized opening of an article adhesively bonded by said adhesive security tape, comprising the double sided adhesive tape of claim 1.

10. The double sided adhesive tape of claim 3 wherein said thickness is from 5 μm to 60 μm.

11. The double sided adhesive tape of claim 10, wherein said thickness is 23 μm.

12. The double sided adhesive tape of claim 6 wherein said reagent is trichloroacetic acid in combination with a crystalline (SiO₂)ₓ compound.
